(19) United States
(12) Patent Application Publication
(10) Pub. No.: US 2006/0078197 A1
(43) Pub. Date: Apr. 13, 2006

(54) Image processing apparatus

(75) Inventors: Daisuke Mitsumoto, Nagaokakyo-shi (JP); Tomoyoshi Aizawa, Kusatsu-shi (JP); Atsuko Tani, Kasugai-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/240,800

(22) Filed: Sep. 30, 2005

(30) Foreign Application Priority Data
Oct. 1, 2004 (JP) 2004-289889

(51) Int. Cl. G06K 9/00

(52) U.S. Cl. 382/154

(57) ABSTRACT

At the time of installing an image processing apparatus using a stereo camera, the plane estimation process cannot be executed in the case where the reference plane is crowded with moving objects. The three-dimensional moving vector of a plurality of feature points extracted from an object moving on the plane is used to determine the normal vector on the plane and calculate the parameter describing the relation between the plane and the camera.

### BACKGROUND OF THE INVENTION

1. Field of the Invention

This invention relates to an image processing apparatus using a stereo image.

2. Description of the Related Art

In the prior art, an apparatus for monitoring the number and type of moving objects by picking up an image of an arbitrary area with a stereo camera finds an application. An apparatus has been proposed, for example, to recognize the type of a running vehicle by calculating the three-dimensional information of the vehicle using the stereo image picked up by two cameras.

In acquiring the three-dimensional information of an object from this stereo image, the three-dimensional position of a reference plane (a flat road surface on which the object moves, etc.) is required to be defined in advance.

The three-dimensional position of a plane is defined by the position of an installed camera relative to the plane. It is difficult, however, to set the camera at the desired position accurately. A method is often employed, therefore, in which the camera is fixedly set at an approximate position and the plane is estimated using an image picked up thereby to acquire the relative positions between the camera and the plane.

In the case where a single image pickup device is used, only a two-dimensional image data is obtained, and to determine whereabouts of a point representing a feature point on the image in a three-dimensional space, the relative positions of at least three feature points in the three-dimensional space are required to be known. For this purpose, in the conventional method, a plane is estimated in such a manner that three or more markers of known relative positions are arranged on the plane, and the correspondence established with the particular points of the markers as feature points thereby to determine relative positions between the plane and the camera based on this information. In this method, however, a correspondence error is caused in the presence of other than the markers on the plane during the setting process. In the case where a monitor is installed on the road to monitor the traffic, for example, the traffic control is required, thereby posing the problem of large installation labor and cost.

In order to solve this problem, a method has been proposed to estimate a plane by use of a feature point such as a dedicated vehicle equipped with markers of known relative positions or a vehicle of a known height and size. Even the use of this method, however, still requires that a dedicated vehicle with markers of which known relative positions or a vehicle of a known height and size are prepared and driven.

In view of these conventional techniques, the present applicant has earlier proposed a method in which neither the markers of known relative positions nor the traffic control is required. This method utilizes the fact that the use of a stereo camera makes it possible to acquire the three-dimensional position of the markers of unknown relative positions. Also, only the feature points existing on the road surface such as white lines (lane edge, center line, etc.) or road marking paint on carriageways or pedestrian walks are extracted from the image to estimate the three-dimensional position of the plane.

According to the method proposed earlier by this applicant, the road paint or the like is imaged by the stereo camera and the feature points thus obtained are utilized to estimate the plane without installing any marker anew. In the case where the plane involved has a uniform texture such as a newly constructed road not yet painted or a floor surface lacking a pattern, however, it is difficult to extract the feature points on the plane and the plane may not be estimated. Also, in the case where the area to be monitored is crowded with moving objects such as vehicles or pedestrians, the feature points on the plane cannot be sufficiently acquired or the feature points on other than the plane cannot be removed, thereby posing the problem that the accuracy of plane estimation is deteriorated.

### SUMMARY OF THE INVENTION

This invention has been achieved in view of this situation, and the purpose thereof is to provide an image processing apparatus which can estimate a plane with high accuracy utilizing the feature points of moving objects even in the case where sufficient feature points cannot be obtained on the plane.

According to the invention, there is provided an image processing apparatus comprising: a feature point extractor for extracting the feature points in an arbitrary image; a corresponding point searcher for establishing the correspondence between the feature points of one of two arbitrary images and the feature points of the other image; a plane estimator for estimating the parameters to describe the relative positions of a plane and an image pickup section in the three-dimensional space; and a standard image pickup unit and at least one reference image pickup unit, both of which are connected to the image pickup section arranged to pickup up an image of the plane; wherein the plane estimator includes: a camera coordinate acquisition unit for supplying the corresponding point searcher, through the feature point extractor, with a standard image picked up by the standard image pickup unit and a reference image picked up by the reference image pickup unit at one time, and determining the relative positions, on the camera coordinate system, between the image pickup section and the points representing the feature points at the time point based on the parallax between the corresponding feature points; a moving vector acquisition unit for supplying the corresponding point searcher, through the feature point extractor, with a first standard image picked up by the standard image pickup unit at a first time point and a second standard image picked up by the standard image pickup unit at a second time point, and determining the three-dimensional moving vectors of the points representing the feature points in the camera coordinate space based on the three-dimensional position of the corresponding feature points in the camera coordinate space at different time points; and a moving vector storage unit for storing, by relating to each other, the first time point, the feature points in the standard images, the camera coordinate of the feature points and the moving vectors; wherein a plane is estimated using the moving vectors stored in the moving vector storage unit.

According to another aspect of the invention, there is provided a method of estimating a plane from a stereo image in an image processing apparatus, comprising the steps of: picking up the stereo imagerepeatedly; determining the three-dimensional coordinate of a feature point in the image picked up at one time point on the camera coordinate system using the principle of triangulation from the parallax of the stereo image and the image coordinate; searching the image picked up at the other time point for a point corresponding to a feature point in the image, and determining a moving vector the feature point on the camera coordinate system within the time interval; and acquiring a parameter defining the plane position using the moving vector.

The use of the image processing apparatus having the configuration and the plane estimation method described above makes it possible to determine a normal vector of the target plane from the track of an object moving on the plane regardless of whether a feature point exists or not on the plane.

Also, in the image processing apparatus having this configuration and the plane estimation method described above, the plane position can be estimated preferably using the coordinate of a point of which the position relative to the plane is known.

As long as a point of which the position relative to the plane is known, or typically, a point on the plane is existent, a reference height to convert the camera coordinate to a coordinate in the real space can be easily determined.

In the absence of a point of which the position relative to the plane is known, on the other hand, the image processing apparatus may be configured to estimate the plane position and the plane estimation method may estimate the plane position on the assumption that the lowest surface is the plane on which the object moves.

By doing so, even in the absence of a point of which the position relative to the plane is known, the plane can be estimated with high accuracy by increasing the number of the feature points.

The image processing apparatus according to the invention may further include a direction setting means for setting the direction beforehand in which an object moves on the image, and the moving vector acquisition unit searches the second standard image for a point corresponding to a feature point in the first standard image only in the direction set by the direction setting means.

With this configuration, the processing amount for establishing the correspondence is reduced and a higher speed operation for establishing the correspondence is made possible.

Further, the image processing apparatus according to the invention may include an image deformer for magnifying or compressing an image, wherein the moving vector acquisition unit may search the second standard image for a point corresponding to a feature point in the first standard image in such a manner that the image deformer executes the process of magnifying or compressing the second standard image in accordance with the ratio between the parallax at a first time point and the parallax at a second time point.

This configuration makes it possible to establish the correspondence at a high speed and with high accuracy.

As described above, with the image processing apparatus or the plane estimation method according to this invention, the relative positions of the plane and the camera can be estimated using the tracking information of an object moving on the plane even in the case where the texture of the target plane is uniform or the target area is so crowded with moving objects that the plane cannot be clearly displayed on the image and a sufficient number of feature points cannot be extracted from the plane.

### BRIEF DESCRIPTION OF THE DRAWINGS

FIG. 1 shows a schematic diagram showing a monitor used for the image processing apparatus according to an embodiment of the invention.

FIG. 2 shows a function block diagram showing a monitor used for the image processing apparatus according to an embodiment of the invention.

FIG. 3 shows a detailed function block diagram showing a portion subjected to the plane estimation process according to an embodiment of the invention.

FIG. 4 shows a diagram showing the relation between the camera coordinate system and the world coordinate system.

FIG. 5 shows a diagram showing the principle of triangulation.

FIG. 6 shows a flowchart showing the flow of the plane estimation process according to an embodiment of the invention.

FIG. 7 shows a diagram for explaining the method of calculating the height of the reference plane using the lowest point.

FIG. 8 shows a function block diagram showing the monitor according to a modification of a first embodiment.

FIG. 9 shows a flowchart showing the flow of the plane estimation process for the monitor according to a modification of the first embodiment.

FIG. 10 shows a diagram showing an example of setting slits.

FIG. 11 shows a function block diagram showing the monitor according to another modification of the first embodiment.

FIG. 12 shows a flowchart showing the flow of the plane estimation process for the monitor according to still another modification of the first embodiment.

FIG. 13 shows a diagram showing the relation between the range of an object on the image and the correlation value.

FIG. 14 shows a diagram showing the relation between the parallax and the size of the object on the image.

FIG. 15 shows a diagram for explaining the method of establishing correspondence by magnifying or compressing the image.

### DESCRIPTION OF THE PREFERRED EMBODIMENTS

Preferred embodiments of the invention are described below.

Unless otherwise specified, the claims of the invention are not limited to the shape, size and relative positions of the component parts described in the embodiments described below.

### Embodiments

### First Embodiment

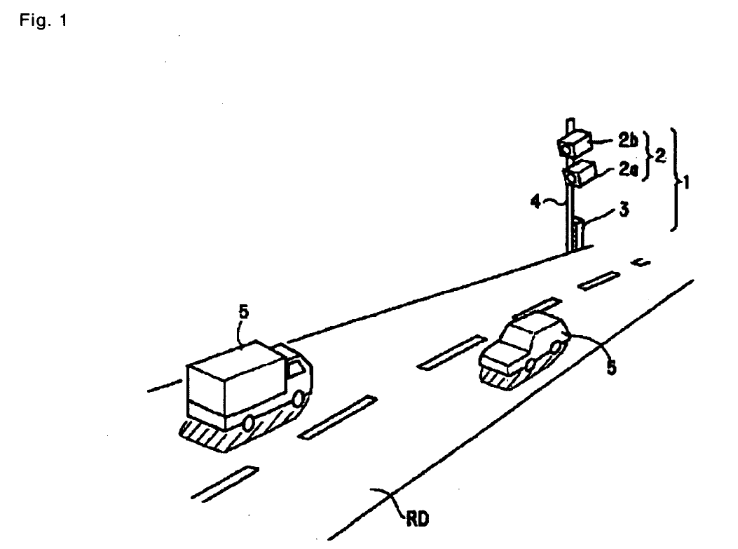

FIG. 1 shows an example of arrangement of a monitor using an image processing apparatus according to an embodiment of the invention.

A monitor 1 is a device for identifying the number and the type of vehicles passing along each lane of a road RD, measuring the running speed of a specified vehicle, grasping the crowded condition and detecting an illegally parked vehicle. The monitor 1 includes a stereo camera 2 and an image processing unit 3.

The stereo camera 2 is an image pickup device configured of a standard image pickup unit 2a and a reference image pickup unit 2b. Each of the image pickup units may be configured as a video camera or a CCD camera. The image pickup units 2a, 2b are arranged vertically in predetermined spaced relation with each other so that the optical axes thereof are parallel. The stereo camera 2 having this configuration is installed on a support pole 4 on the side of a road RD to pick up the image of each running vehicle 5. Although two image pickup units are used in the case of FIG. 1, three or more image pickup units may alternatively be used. Also, the image pickup units may be arranged horizontally instead of vertically.

The image processing unit 3 has a CPU (central processing unit), a ROM (read-only memory) and a RAM (random access memory) as basic hardware. During the operation of the monitor 1, the program stored in the ROM is read and executed by the CPU thereby to implement the functions described later. The image processing unit 3 is preferably installed in the neighborhood of the root of the support pole 4 to facilitate maintenance and inspection.

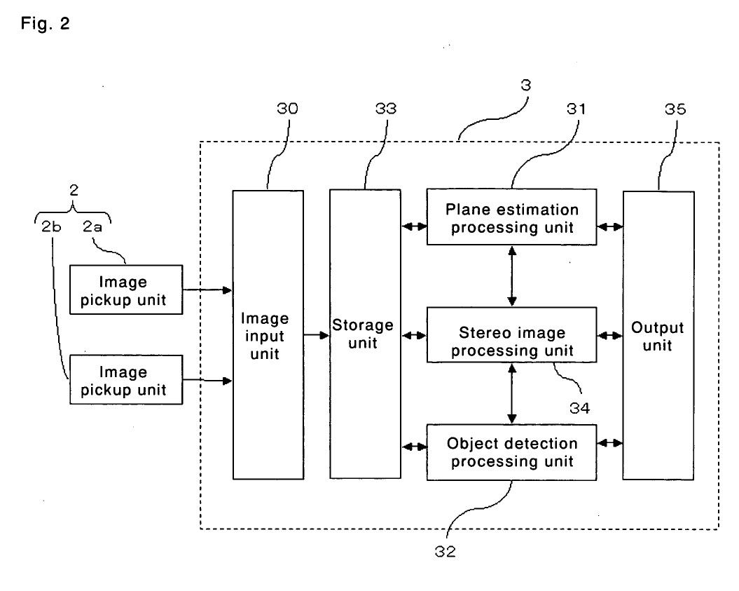

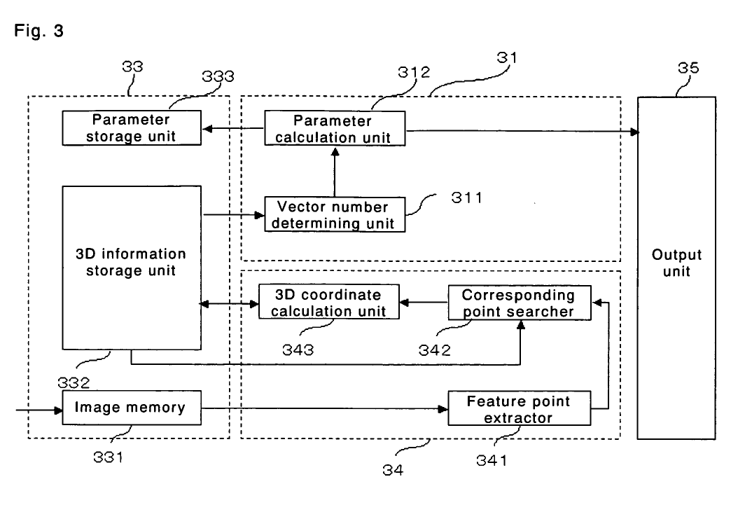

FIG. 2 is a function block diagram showing the functional configuration of the monitor 1. FIG. 3 is a detailed view of the function blocks related to the plane estimation process as extracted from the functions shown in FIG. 2. As shown in FIG. 2, the image processing unit 3 roughly includes an image input unit 30, a plane estimation processing unit 31, an object detection processing unit 32, a storage unit 33, a stereo image processing unit 34 and an output unit 35. The image input unit 30 is the function for inputting the image signal obtained from the stereo camera 2 to the image processing unit 3. In the case where the image signal is in analog form, a digital image A/D converted by the image input unit 30 is input. The two image data thus input are stored in the image memory 331 of the storage unit 33 as a stereo image. The image thus retrieved is either a color or monochromatic image (variable density image), although the latter is sufficient for the purpose of vehicle detection.

The plane estimation processing unit 31 functions as a plane estimation means for estimating the three-dimensional position of a plane (road RD) along which the vehicles 5 move, from the stereo image retrieved by the image memory 331. Immediately after installing the vehicle detector 1, the relative positions of the image pickup units 2a, 2b and the road RD are not yet known, and therefore the three-dimensional coordinate of a given feature point in the real space cannot be determined. First, therefore, the plane estimation process is executed to calculate the parameters defining the relative positions of the stereo camera 2 and the road RD. As shown in FIG. 3, the plane estimation processing unit 31 is in reality configured of a vector number determining unit 311 and a parameter calculation unit 312. The plane estimation processing unit 31, however, is not adapted to execute the process on its own, but estimates a plane using the information acquired by the stereo image processing unit 34. This process is explained in detail later.

The three-dimensional position of the plane calculated by the plane estimation processing unit 31 is stored as a parameter in the parameter storage unit 333. Also, in order to check whether the plane estimation has been normally conducted or not, the plane data can be output as required from the output unit 35. The output unit 35 may constitute a display, printer, etc.

The object detection processing unit 32, after executing the plane estimation process, conducts the actual monitor operation. Although the specifics of the monitor operation are not described in detail, the object detection processing unit 32 is also not adapted to execute the process on its own, but the object may be detected or the speed monitored by use of an appropriate combination of the information acquired by the stereo image processing unit 34.

The stereo image processing unit 34 is a means for acquiring the three-dimensional information by processing the stereo image introduced into the image memory 331. In the stage before executing the plane estimation process, the relative positions of the stereo camera 2 and the road RD are not known, and therefore the three-dimensional information is acquired based on the stereo camera 2. After execution of the plane estimation process, on the other hand, the three-dimensional information in the real space is acquired using the parameters stored in the parameter storage unit 333. This process is explained in detail later.

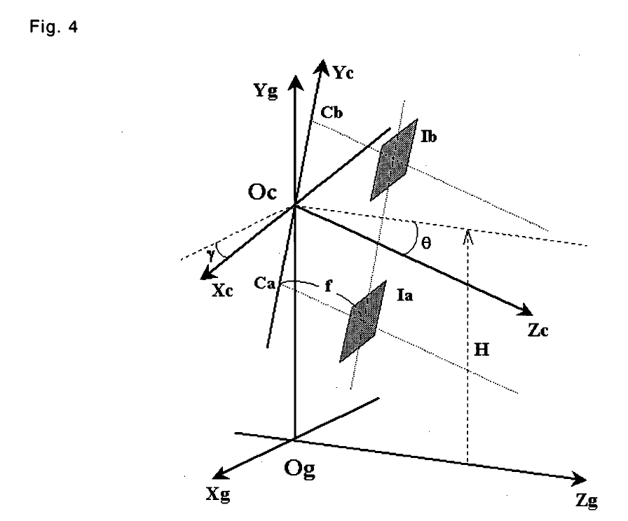

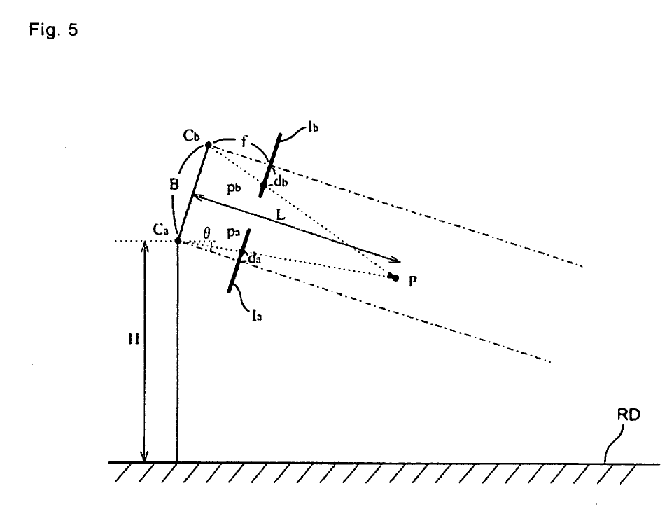

Before explaining the plane estimation process constituting the feature of this invention, a method of calculating the three-dimensional coordinate in the real space by processing the stereo image is briefly explained with reference to FIGS. 4 and 5.

As described above, the three-dimensional position of the plane is obtained as the relative positions of the stereo camera 2 and the road RD. More specifically, the three-dimensional position of the plane is defined by three parameters including the height H of the stereo camera 2 with respect to the road RD, the depression angle θ of the optical axis of the stereo camera 2 with respect to the plane, and the normal angle γ indicating the difference between the straight lines passing through the center of the lenses of the two image pickup units of the stereo camera 2 and the vertical direction in the real world. These three parameters are hereinafter referred to collectively as the plane data.

FIG. 4 shows the relation between the stereo camera for the stereo image processing and the real space. The XcYcZc coordinate system is a camera coordinate system having the origin at the middle point between the lens centers of the two cameras and the direction of the optical axis along the Zc axis. According to this embodiment, the cameras are arranged vertically, and therefore the axis passing through the two lens centers is defined as the Yc axis. The XgYgZg coordinate system, on the other hand, is the world coordinate system, i.e. the coordinate system representing the three-dimensional coordinate in the real space having the Yg axis along the vertical direction. Also, the XgZg plane is a reference plane, which is the road RD according to this embodiment. The origin Og is located immediately below the origin Oc of the camera coordinate system, and the distance H between Og and Oc is the installation height of the camera.

On the assumption of the aforementioned definitions, the relation between the camera coordinate system and the world coordinate system is expressed by the following equation.

$$( \begin{matrix}{X}_{g} \\ {Y}_{g} \\ {Z}_{g}\end{matrix} ) = ( \begin{matrix}1 & 0 & 0 \\ 0 & cos θ & - sin θ \\ 0 & sin θ & cos θ\end{matrix} ) ( \begin{matrix}cos γ & - sin γ & 0 \\ sin γ & cos γ & 0 \\ 0 & 0 & 1\end{matrix} ) ( \begin{matrix}{X}_{c} \\ {Y}_{c} \\ {Z}_{c}\end{matrix} ) + ( \begin{matrix}0 \\ H \\ 0\end{matrix} ) \qquad [ Equation 1 ]$$

Specifically, the world coordinate system is considered the camera coordinate system rotated by the depression angle θ and the normal angle γ and displaced downward in vertical direction by the height H.

Next, the principle of triangulation is explained with reference to FIG. 5. FIG. 5 corresponds to a diagram in which the camera coordinate system of FIG. 4 is projected on the Yc axis.

In FIG. 5, characters Ca, Cb designate the lens centers of the standard image pickup unit 2a and the reference image pickup unit 2b, respectively. Let f be the focal length of the lenses of the image pickup units 2a, 2b and B the center distance (base length) between the lenses. The images Ia, Ib picked up are considered as planes spaced by the distance f from Ca, Cb as shown.

A point P in the real space appears at the position of points pa, pb in the standard image Ia and the reference image Ib. The point pa indicating the point P in the standard image Ia is called a feature point, and the point pb indicating the point P in the reference image Ib as a corresponding point. The sum (da+db) of the coordinate value da in the image Ia of the feature point pa and the coordinate value db in the image Ib of the corresponding point pb is the parallax d of the point P.

In the process, the distance L from the imaging surface of the image pickup units 2a, 2b to the point P is calculated by L=Bf/d using the proportionality relation between the sides and length of a triangle. This is the principle of distance measurement based on triangulation.

The vector (Xc, Yc−B/2, Zc) directed to point P from the lens center Ca of the standard image pickup unit 2a is an integer multiple of the vector directed from Ca to pa. The vector directed from Ca to pa is given as (xc, yc, f). Since Zc=L, the relation between the coordinate on the image and the coordinate on the camera coordinate system can be described as shown below by using the equation L=Bf/d described above.

$$( \begin{matrix}{X}_{c} \\ {Y}_{c} \\ {Z}_{c}\end{matrix} ) = \frac{B}{d} ( \begin{matrix}{x}_{cl} \\ {y}_{cl} \\ {f}_{cam}\end{matrix} ) - ( \begin{matrix}0 \\ \frac{B}{2} \\ 0\end{matrix} ) \qquad [ Equation 2 ]$$

The use of this equation makes it possible to determine the coordinate (Xc, Yc, Zc), on the camera coordinate system, of the point pa at the position (xcl, ycl) in the standard image.

By substituting the three-dimensional position on the camera coordinate system determined by the aforementioned process into Equation 1, the three-dimensional position in the world coordinate system, i.e. the three-dimensional position in the real space can be determined. An application of Equation 1 requires that the plane data H, θ, γ are required to be determined. Moreover, the higher the accuracy of these plane data, the higher the accuracy with which the three-dimensional position in the real space can be calculated. To improve the accuracy of the operation of monitoring an object, therefore, it is important to acquire the plane data with high accuracy.

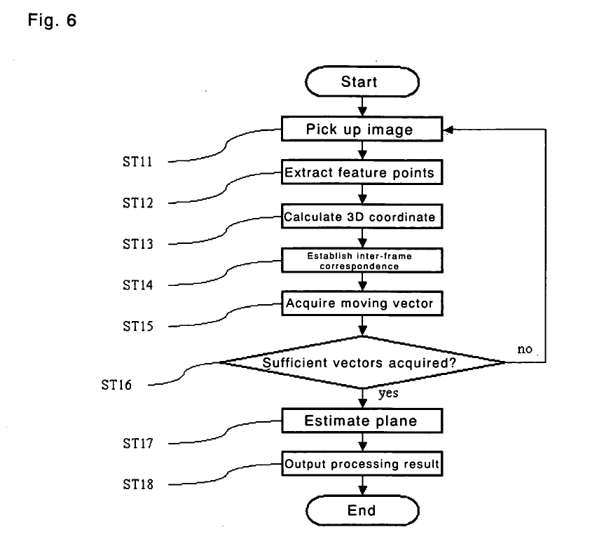

Next, the plane estimation process is explained in detail with reference to the flowchart of FIG. 6. The plane estimation process generally comprises the steps of collecting the moving vectors by picking an image of the plane, at predetermined intervals of time Δt, on which the moving object exists, and calculating the parameter using the collected moving vectors. The predetermined time interval Δt at which the image is picked up can be set by the user arbitrarily in such a manner that the same object exists in two images picked up at the predetermined intervals of time Δt and that the movement of the object can be recognized between the two images. Also, according to this embodiment, as described later, the moving vectors are collected by executing the process of establishing correspondence in real time using the present image and the image picked up the predetermined time Δt earlier. In the case where the processing speed of the image processing unit 3 is low, however, the images picked up at predetermined intervals are accumulated in the image memory 331 in time series, and can be read and processed at different timing.

First, at step ST11, a stereo image is picked up by the stereo camera 2. The images retrieved from each image pickup unit are stored in the image memory 331 through the image input unit 30. In the process, the image input unit 30 converts the image to digital data as required. The digital variable density image data thus generated is retrieved into the image pickup unit 2a as a standard image Ia on the one hand, and into the image pickup unit 2b as a reference image Ib on the other hand, both of which are stored in the image memory 331.

At step ST12, the feature point extractor 341 extracts the feature point from the standard image Ia stored in the image memory. Various methods of setting or extracting the feature point have been conceived. In the case where a pixel having a large difference in brightness from the adjacent pixels is used as a feature point, for example, the feature point is extracted by scanning the image with a well-known edge extraction operator such as the Laplacian filter or Sobel filter. At this step, the profile of each vehicle 5, the lane markings of the road RD, etc. are extracted as feature points.

Next, at step ST13, the corresponding point searcher 342 reads the standard image Ia and the reference image Ib, and with regard to each feature point extracted at step ST12, a corresponding point is searched for in the reference image and correspondence is established. Specifically, the corresponding point searcher 342 first cuts out an area in the neighborhood of a feature point as a small image ia. Then, for each pixel making up the reference image Ib, a small area ib as large as the small image ia is set, followed by checking whether the small image ia and the small area ib are similar to each other or not. The similarity is determined by correlating the small image ia and the small area ib to each other, and a point where the correlation of not less than a predetermined threshold value is secured is determined as a corresponding point. Once the corresponding point pb is acquired from the reference image Ib, the corresponding point searcher 342 sends the coordinates of the feature point pa and the corresponding point pb on the image to the three-dimensional coordinate calculation unit 343. The three-dimensional coordinate calculation unit 33 determines the parallax d from the received coordinate on the image, and substitutes the coordinate of the feature point pa and the parallax d into Equation 2 thereby to calculate the three-dimensional coordinate on the camera coordinate system. The three-dimensional coordinate thus calculated is sent to the corresponding point searcher for executing the process to establish the inter-frame correspondence at the next step. At the same time, the three-dimensional coordinate and the coordinate on the image and the small image ia in the neighborhood of the feature point are correlated to each other for each feature point, and stored in the three-dimensional information storage unit 332 for use in the next image pickup process.

At step ST14, the corresponding point searcher 342 determines a particular position assumed by each feature point on the standard image picked up a predetermined time Δt earlier. More specifically, the corresponding point searcher 342 reads the small images ia′, ia′, . . . in the neighborhood of the feature point as of a predetermined time Δt earlier, stored in the three-dimensional information storage unit 332 and compares them sequentially with the small images ia, ia, . . . cut out at step ST13 to secure the correlationship. In the case where the correlation value between the small images is not less than a preset threshold as in the case of step ST13, the correspondence between the points indicated by the central pixels thereof at about a predetermined time point Δt is determined as established.

At step ST15, the three-dimensional information calculation unit 343 calculates the moving vector from the difference between the present three-dimensional position and the three-dimensional position a predetermined time At earlier, on the camera coordinate system, of the sets of the feature points obtained at step ST14. The moving vector thus calculated is stored in the three-dimensional information storage unit 332.

At step ST16, the vector number determining unit 311 determines whether a group of moving vectors required for plane estimation are sufficiently collected or not. In a determination method, for example, the number of feature point sets of which correspondence is established between the frames or the total size of the moving vectors is checked. In the case where the vector group is sufficiently large to estimate the plane, the process proceeds to step ST17. Otherwise, the process returns to step ST11, so that the image is picked up a predetermined time Δt later and the process is repeated subsequently to collect the vectors.

Using the moving vector group obtained at the aforementioned steps, the parameter calculation unit 312 estimates a plane (step ST17). At this step, the parameter calculation unit 312 substitutes the moving vector (axi, ayi, azi) (i: natural number) into the following equation to determine the parameter.

$$θ = {tan}^{- 1} ( \frac{{a}_{xi} tan γ + {a}_{yi}}{{a}_{zi} cos γ} ) \qquad [ Equation 3 ]$$

Specifically, the depression angle θ and the normal angle γ satisfying the equation above can be calculated by executing the statistical process such as the least square method and the Hough transformation using sufficiently many moving vectors.

The depression angle θ and the normal angle γ thus calculated are stored in the parameter storage unit 333, or may alternatively be output from the output unit 35 for confirmation (step ST18).

As the result of executing this process, the depression angle θ and the normal angle γ constituting the angular relation between the camera coordinate system and the world coordinate system shown in FIG. 4 can be acquired. In order to uniquely define the relative positions of the stereo camera 2 and the road RD, however, the calculation of the installation height H of the stereo camera 2 is required.

As long as the stereo camera 2 is installed in the manner shown in FIG. 1, the camera installation height H can be determined by directly measuring the length of the support pole 4 even in the case where the road RD is crowded with vehicles. The height H cannot be easily determined directly, however, in the case where the stereo camera 2 is mounted indoor on the ceiling of a room.

In such a case, two methods are available to measure the camera installation height H.

The first method uses at least one of the feature points of which the position relative to a plane is known. This applies to a case, for example, in which a plurality of feature points derived from a fixed object (paint, rivets, etc. for the road) on the plane are included in the feature points acquired.

A fixed object on the plane is immovable and therefore acquired as a point with the moving vector of substantially zero. The coordinate on the image of this point is substituted into Equation 4 to acquire the height H.

$$H = \frac{B ( f sin θ - y cos θ cos γ - x cos θ sin γ )}{d} + \frac{1}{2} B cos θ cos γ \qquad [ Equation 4 ]$$

The second method is to use the lowest one of the feature points constituting the collected moving vectors. A moving object is considered to move at least on or above the road RD, and therefore the lowest one of the feature points extracted from the moving objects on the image can be regarded as a point on the plane. Such a point can be acquired also from a fixed object on the plane. Even in the absence of a fixed object on the plane, however, such a point can be acquired from the boundary between the target plane and the moving object or the edge of a shadow of the object projected on the plane.

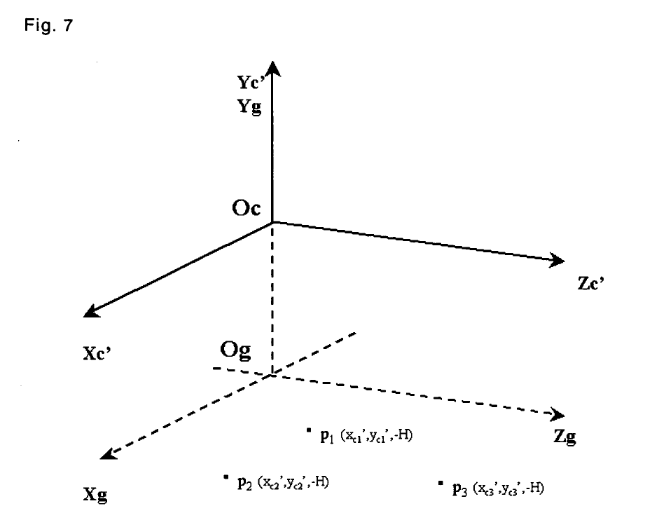

The height of a feature point in the real space can be acquired in the following manner. As described above, the depression angle θ and the normal angle γ are already calculated, and therefore the camera coordinate system can be rotated toward the world coordinate system using Equation 5. As shown in FIG. 7, the coordinate system obtained by rotation has the origin at the position Oc. Although the height H is unknown, the coordinate system obtained by rotation has the same direction of the coordinate axis as the world coordinate system, and therefore the relative heights of the feature points can be determined. Specifically, in the case of FIG. 7, the plane containing the lowest points p1, p2, p3, . . . can be estimated as the target plane, so that the amount of vertical displacement of the coordinate system obtained by rotation, i.e. the camera installation height H can be determined.

$$( \begin{matrix}{X}_{g} \\ {Y}_{g}^{′} \\ {Z}_{g}\end{matrix} ) = ( \begin{matrix}1 & 0 & 0 \\ 0 & cos θ & - sin θ \\ 0 & sin θ & cos θ\end{matrix} ) ( \begin{matrix}cos γ & - sin γ & 0 \\ sin γ & cos γ & 0 \\ 0 & 0 & 1\end{matrix} ) ( \begin{matrix}{X}_{c} \\ {Y}_{c} \\ {Z}_{c}\end{matrix} ) \qquad [ Equation 5 ]$$

(First Modification)

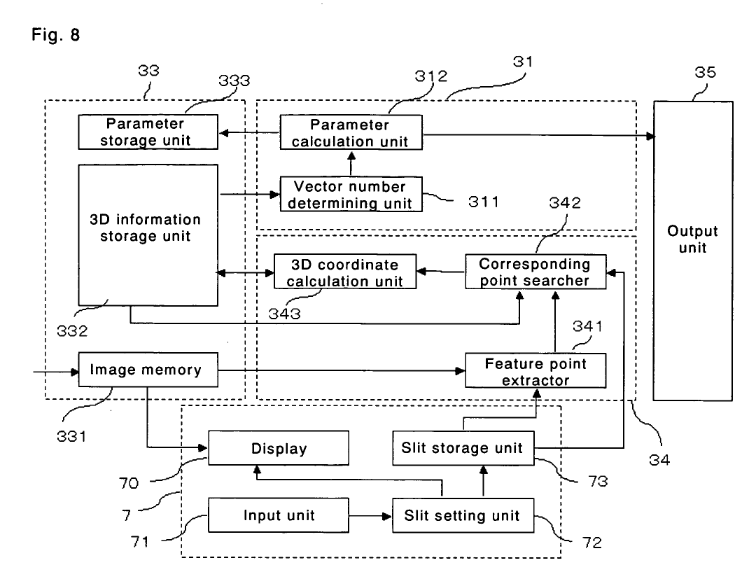

FIG. 8 is a block diagram showing a monitor 1 according to a modification of the first embodiment.

The monitor shown in FIG. 8 has a moving direction designator 7. The other parts of the configuration and the operation are identical to and designated by the same reference numerals as those of the first embodiment, and not described any longer.

The moving direction designator 7 includes a display unit 70 such as a liquid crystal display, an input unit 71 such as a mouse or a keyboard, a slit setting unit 72 and a slit storage unit 73. The plane estimation process is executed only once at the time of installing the monitor 1. Similarly the slit setting process is executed only once for the first image at the time of executing the plane estimation process. In view of this, a portable terminal such as a mobile computer or a PDA is temporarily connected to the image processing unit 3 as a moving direction designator 7 preferably to save the cost and facilitate the maintenance. Alternatively, however, a part or the whole of the moving direction designator 7 may be implemented as the internal functions of the image processing unit 3.

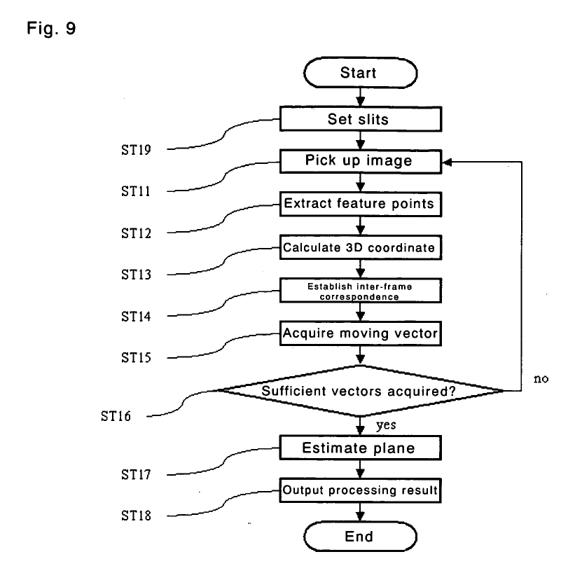

With reference to the flowchart of FIG. 9, the plane estimation process according to this modification is explained. The plane estimation method according to this modification has the feature in that the slit setting process of step ST19 is executed before the plane estimation process according to the first embodiment.

At step ST19, the standard stereo image stored in the image memory is transmitted to the moving direction designator 7 and displayed on the display unit 70.

The user (installation worker), while referring to the standard image displayed on the display unit 70, designates the direction in which the moving object moves in the image using the input unit 71. In the case where the target monitor area is a road and the moving object is a vehicle, for example, the moving object is considered to move substantially in parallel to the lane, and therefore, by designating the two side lines of the lane, the moving direction can be designated. In the case where the target monitor area is the conveyor line in the factory, on the other hand, the moving direction can be designated by designating the both edges of a conveyor belt. The moving direction can be designated sufficiently by designating two or more straight lines or curves. The designated straight lines or the curves defining the moving direction of the object are transmitted to the slit setting unit 72 as a reference line r.

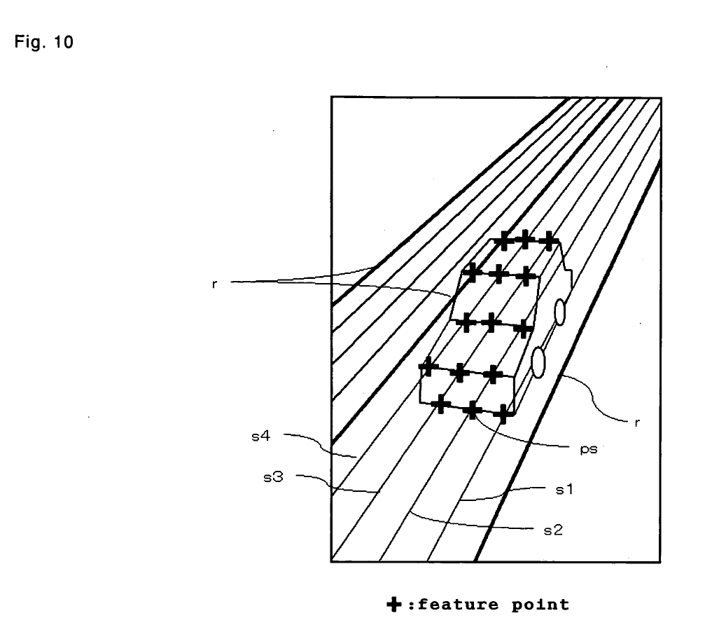

The slit setting unit 72 causes the corresponding point searcher 342 to establish the correspondence of two or more points making up the designated reference line r with the reference image and acquire the three-dimensional information of the reference line r on the camera coordinate system through the three-dimensional coordinate calculation unit 343. Then, the slit setting unit 72, based on the three-dimensional information of the reference line r thus obtained, sets three-dimensionally equidistant slits s1, s2, . . . (FIG. 10). In the case of FIG. 10, the end of each lane of the road RD is used as the reference line r. The slits s are defined a group of lines parallel to the reference line r and arranged at same intervals on the plane defined by the reference lines r, r. The interval between the slits s is required to be set smaller than the minimum width of the object moving on the plane. In the case where the moving object is a vehicle, however, the interval can be set to not more than about the width of the light vehicle. The information (the three-dimensional coordinate and the image coordinate on the camera coordinate system) of the slits s set in this way are stored in the slit storage unit 73 and displayed on the display unit 70 for confirmation.

At step ST12′, the feature point extractor 341 reads the standard image from the image memory 331 and the image coordinates of the slits s1, s2, . . . from the slit storage unit 73, and searches for only the points on the slits s in the image to extract the feature point. Further, at step ST14′, the corresponding point searcher 342 searches one-dimensionally along the slit having the feature point at the preceding time point. In the case where the feature points for which the corresponding points are sought are the points ps in FIG. 10, for example, the corresponding point searcher 342 scans only along the slit s4 and establishes correspondence.

In the case where the moving direction is considered substantially constant as described above, slits parallel to the moving direction are set, and the process executed along the set slits. In this way, the processing time can be shortened and the track of the moving object can be efficiently extracted.

It is also preferred that, at step ST14′, a plurality of slits including the adjacent slits for the present feature point are searched. By doing that, even in the case where the object moves in the direction displaced from the set moving direction, the correspondence can be established.

(Second Modification)

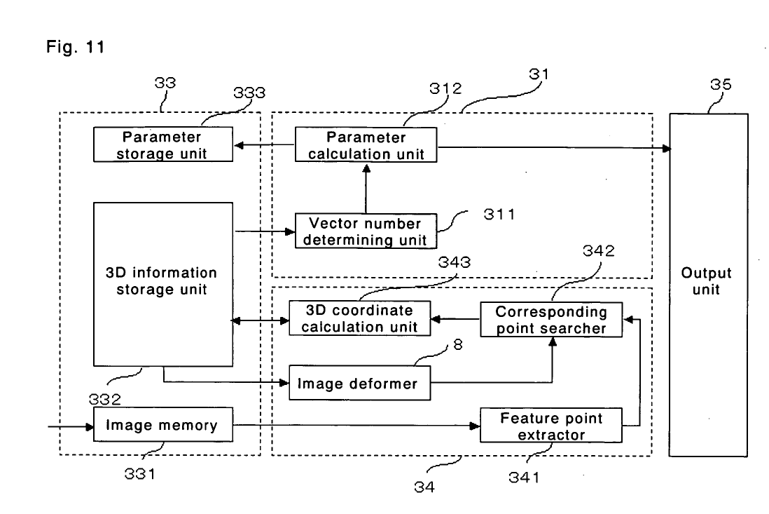

FIG. 11 is a block diagram showing the monitor 1 according to another modification of the first embodiment.

The monitor shown in FIG. 11 is so configured that an image deformer 8 is added to the image processing unit 3 according to the first embodiment.

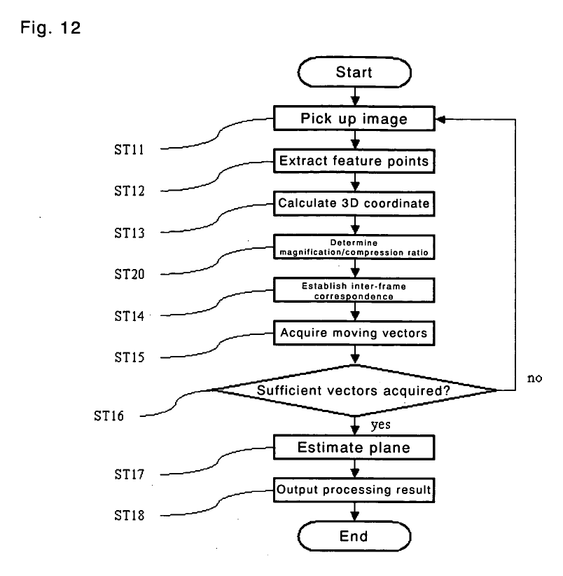

With reference to the flowchart of FIG. 12, the plane estimation process according to this modification is explained. The plane estimation method according to this modification, though substantially similar to the method in the first embodiment, has the feature that before executing the process of establishing correspondence between the frames at step ST14, the magnification/compression ratio determining process is executed at step ST20 to magnify or compress the small search image ia cut out from the standard image Ia at a given time point or to determine the size of the small area ia′ to be cut out from the standard image Ia′ picked up at another time point. The magnification/compression ratio determining process is explained in detail below.

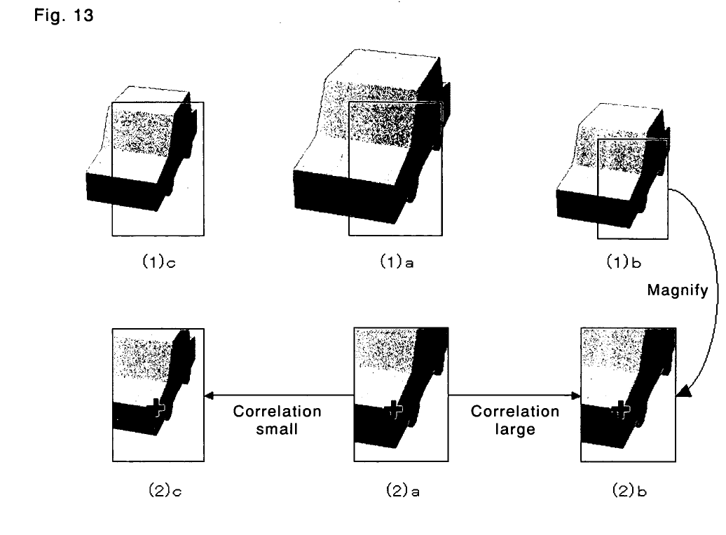

The movement of an object changes the distance from the image pickup means to the object and so does the size of the image of the object displayed. In establishing correspondence between frames, the correlation value is reduced in the case where the range of display in the small area is not the same even when watching the same pixel as shown in FIG. 13. In the process of establishing the correspondence, the small image ia and the small area ia′ to be correlated are required to be the same in size. In order to assure that the same range of the same object may be displayed in the small area ia′ and the small image ia of the same size after the size on the image is changed, therefore, the small image ia is required to be magnified or compressed in accordance with the size change ratio of the object on the image in advance and then the small area ia′ of the size after magnification or compression, as the case may be, is cut out. As an alternative, the small area ia′ of the size corresponding to the change ratio of the object size on the image is cut out and compressed or magnified to secure correlation in accordance with the size of the small image ia. As long as the size change amount of an object on the image is unknown, however, the required size change to cut out the same range is unknown, and therefore the repetitive scan operation is required while changing the magnification/compression ratio.

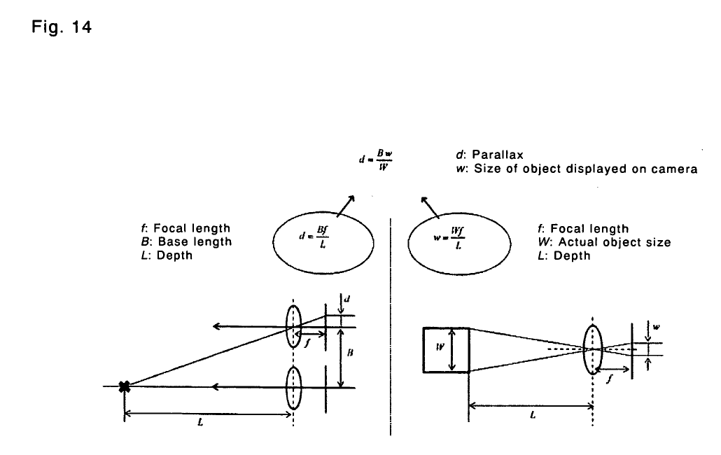

As shown in FIG. 14, the relation between the actual three-dimensional size W and the depth L is expressed as w=Wf/L, where w is the size of the object displayed on the image. On the other hand, the relation between the distance L to a given point in the three-dimensional space from the camera and the parallax d at the particular point is given as d=Bf/L. Thus, the relation between the parallax d and the size w on the image is expressed as d=(B/W)·w. This equation indicates that the parallax d and the size w on the image are proportional to each other. Specifically, the change ratio of the size on the image due to the movement of the object is equal to the parallax change ratio, and therefore the size on the image can be uniquely determined by utilizing the parallax change ratio.

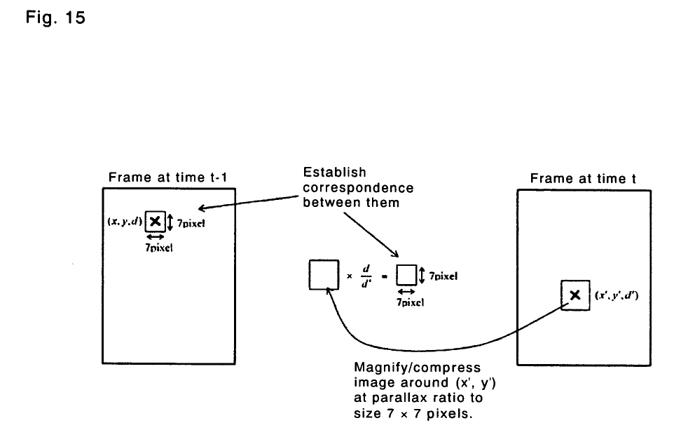

In establishing the inter-frame correspondence between the standard image Ia at time point t-1 and the standard image Ia′ at time point t, for example, as shown in FIG. 15, assume that d is the parallax at time point t-1, the small image ia is “7 pixel square” and d′ is the parallax at time point t. Then, the size of the small area ia′ to be cut out is given as the square of 7×d′/d. Thus, the small area ia′ is cut out to the particular size and magnified or compressed to “7 pixel square” to secure correlation with the small image ia.

As described above, by uniquely determining the size of the small area to be cut out utilizing the parallax change ratio of each feature point, the repetitive search while changing the magnification/compression ratio of the small image is not required, and the search process can be executed at high speed.

What is claimed is:

1. An image processing apparatus comprising:
a feature point extractor for extracting the feature points in an arbitrary image;
a corresponding point searcher for establishing the correspondence between the feature points of one of two arbitrary images and the feature points of the other image;
a plane estimator for estimating the parameters to describe the relative positions of a plane and an image pickup section in the three-dimensional space; and
a standard image pickup unit and at least one reference image pickup unit, both of which are connected to the image pickup section arranged to pickup up an image of the plane;
wherein the plane estimator includes:
a camera coordinate acquisition unit for supplying the corresponding point searcher, through the feature point extractor, with a standard image picked up by the standard image pickup unit and a reference image picked up by the reference image pickup unit at one time point, and determining the relative positions, on the camera coordinate system, between the image pickup section and the points representing the feature points at the time point based on the parallax between the corresponding feature points;
a moving vector acquisition unit for supplying the corresponding point searcher, through the feature point extractor, with a first standard image picked up by the standard image pickup unit at a first time point and a second standard image picked up by the standard image pickup unit at a second time point, and determining the three-dimensional moving vectors of the points representing the feature points in the camera coordinate space based on the three-dimensional position of the corresponding feature points in the camera coordinate space at different time points; and
a moving vector storage unit for storing, by relating to each other, the first time point, the feature points in the standard images, the camera coordinate of the feature points and the moving vectors;
wherein a plane is estimated using the moving vectors stored in the moving vector storage unit.

2. An image processing apparatus according to claim 1,
wherein the plane estimator estimates a plane using the feature points of which the position relative to the plane is known, in addition to the moving vectors.

3. An image processing apparatus according to claim 1,
wherein the plane estimator estimates a plane by regarding the lowest one of a plurality of planes defined by the moving vectors as a plane along which an object moves.

4. An image processing apparatus according to claim 1, further comprising a direction setting device for presetting the direction in which the object moves on the image,
wherein the moving vector acquisition unit searches the second standard image for points corresponding to the feature points in the first standard image in the direction set by the direction setting device.

5. An image processing apparatus according to claim 1, further comprising an image deformer for magnifying or compressing an image,
wherein the moving vector acquisition unit causes the image deformer to execute the process of magnifying or compressing selected one of the first standard image and the second standard image in accordance with the ratio between the parallax at the first time point and the parallax at the second time point while searching the second standard image for a point corresponding to a feature point in the first standard image.

6. A method of estimating a plane from a stereo image in an image processing apparatus, comprising the steps of:
picking up the stereo image repeatedly;
determining the three-dimensional coordinate of a feature point in the image picked up at one time point on the camera coordinate system using the principle of triangulation from the parallax of the stereo image and the image coordinate;
searching the image picked up at the other time point for a point corresponding to a feature point in the image, and determining a moving vector the feature point on the camera coordinate system within the time interval; and
acquiring a parameter defining the plane position using the moving vector.

7. A plane estimation method according to claim 6,
wherein the parameter is acquired at the parameter acquisition step using, in addition to the moving vector, the coordinate of the feature point of which the position relative to the plane is known, in addition to the moving vector.

8. A plane estimation method according to claim 6,
wherein the parameter is acquired at the parameter acquisition step by regarding the lowest one of the feature points as a point of height 0 in the real space.

9. A plane estimation method according to claim 6,
wherein the image picked up at the other time point is searched for a point corresponding to the feature point in the image by magnifying or compressing selected one of the image picked up at a first time point and the image picked up at a second time point in accordance with the ratio of parallax between the first time point and the second time point.
